(19) United States
(12) Patent Application Publication
(10) Pub. No.: US 2020/0135019 A1
(43) Pub. Date: Apr. 30, 2020

(54) SIGNAL CONTROL DEVICE, SIGNAL CONTROL SYSTEM, AND SIGNAL CONTROL METHOD

(71) Applicant: PANASONIC INTELLECTUAL PROPERTY MANAGEMENT CO., LTD., Osaka (JP)

(72) Inventors: Yuzo HIROTSU, Kanagawa (JP); Koichiro IWAOKA, Kanagawa (JP)

(73) Assignee: PANASONIC INTELLECTUAL PROPERTY MANAGEMENT CO., LTD., Osaka (JP)

(21) Appl. No.: 16/617,831

(22) PCT Filed: May 31, 2018
(86) PCT No.: PCT/JP2018/020883

§ 371 Date: Nov. 27, 2019

(30) Foreign Application Priority Data
Jun. 21, 2017 (JP) 2017-121254

(51) Int. Cl. G08G 1/08

(52) U.S. Cl. CPC G08G 1/08

(57) ABSTRACT

A signal control device including a processor that provides signal control information for controlling a traffic light installed at an intersection has a configuration in which the processor calculates number of times of signal waiting of a vehicle in a plurality of vehicle outflow directions at the intersection, and determines an adjustment value of a passage permission time for the signal control information of the traffic light relating to the vehicle outflow direction, based on the number of times of signal waiting.

### TECHNICAL FIELD

The present disclosure relates to a signal control device, a signal control system, a signal control method, and a signal control program that provide signal control information for controlling a traffic light installed at an intersection or the like.

### BACKGROUND ART

In a related art, in a traffic signal control relating to a traffic light installed at an intersection or the like, for the purpose of reducing traffic jam and congestion and ensuring a smooth traffic flow, review for a rational operation of the traffic light including a change in a signal control method depending on a change in a traffic situation on a road network is implemented. Meanwhile, due to reduction of a public work expense in recent years and reduction of a specialist relating to a road management and a traffic management, there is a concern about deterioration of the traffic situation due to a prolonged operation review cycle, and an efficient and effective new review method which uses a management system is expected.

In the operation review of the traffic light, for example, a change of a signal control method and improvement of an intersection are considered, but a relatively high cost is required for introduction of new equipment. In contrast to this, there is an advantage that the operation review of the traffic light based on a change in control setting information (furthermore, signal control information) can be implemented at a relatively low cost. Concerning the change in control setting information, particularly, if the amount of blue time (passage permission time) in a plurality of vehicle outflow directions at an intersection is inappropriate, it will directly lead to traffic jam and congestion, and thus, it is desirable to review the blue time appropriately depending on a continuous change in a traffic situation.

As a technique of related art for realizing an appropriate signal control depending on the change in a traffic condition, for example, in a signal control device for controlling a traffic light that gives a passage permission independently of other outflow directions with respect to a specific outflow direction from an intersection, in a case where it is determined that an outflow in a specific outflow direction is not smooth based on probe information, a technology of extending blue time for a specific outflow direction (see PTL 1), and a technique (see Patent Document 2) in which a signal control device for controlling a lamp color of a traffic light by selecting one of signal control patterns previously stored according to a use time zone updates the use time zone of the selected signal control pattern to a certain time zone such that the signal control pattern selected according to a statistical value of a traffic index for each certain time zone is used in a certain time zone, are known.

### CITATION LIST

### Patent Literature

PTL 1: U.S. Pat. No. 5,729,028

PTL 2: U.S. Pat. No. 5,445,471

### SUMMARY OF THE INVENTION

### Technical Problems

By the way, in the prior art described in above-described PTL 1, In order to perform determination that an outflow in a specific outflow direction (for example, right turn direction) is not smooth based on probe information, in a case where many vehicles that provide the probe information do not travel on a target road, there is a problem that it is difficult to perform a signal control appropriately.

Further, a technology of the related art described in PTL 2 only uses a signal control pattern selected from a previously prepared signal control pattern, and further, a specific method for appropriately calculating the signal control pattern is not disclosed therein, and thereby, there is a problem that cannot cope with a continuous change in a traffic situation.

The present disclosure is devised to solve the problems of the related art, and a main object thereof is to provide a signal control device, a signal control system, a signal control method, and a signal control program that enable a control of a traffic light depending on a continuous change in a traffic situation.

### Solutions to Problems

A signal control device according to the present disclosure is a signal control device including a processor that provides signal control information for controlling a traffic light installed at an intersection, in which the processor calculates number of times of signal waiting of a vehicle in a plurality of vehicle outflow directions at the intersection, and determines an adjustment value of a passage permission time for the signal control information of the traffic light relating to the vehicle outflow direction, based on the number of times of signal waiting.

Further, a signal control system according to the present disclosure is a signal control method of providing signal control information for controlling traffic light installed at an intersection including calculating number of times of signal waiting of a vehicle in a plurality of vehicle outflow directions at the intersection, and determining an adjustment value of a passage permission time for the signal control information of the traffic light relating to the vehicle outflow direction, based on the number of times of signal waiting.

Further, a signal control method according to the present disclosure includes the signal control device, and an on-road communication device that acquires information on a travel time of a vehicle passing through the intersection.

Further, a signal control program according to the present disclosure is a signal control program for causing a computer to perform a process of providing signal control information for controlling a traffic light installed at an intersection, and causes the computer to perform a step of calculating number of times of signal waiting of a vehicle for a plurality of vehicle outflow directions at the intersection, and a step of determining an adjustment value of a passage permission time for the signal control information of the traffic light relating to the vehicle outflow direction, based on the number of times of signal waiting.

### Advantageous Effect of Invention

According to the signal control device, the signal control system, the signal control method, and the signal control program of the present disclosure, it is possible to control a traffic light according to a continuous change in a traffic situation.

### BRIEF DESCRIPTION OF DRAWINGS

FIG. 1 is an overall configuration diagram illustrating a signal control system according to an embodiment.

FIG. 2 is a functional block diagram illustrating details of the signal control system illustrated in FIG. 1.

FIG. 3 is an explanatory diagram illustrating an example of a road network in which a traffic signal to which the signal control system is applied is installed.

FIG. 4A is an explanatory diagram illustrating a first example of a peripheral configuration of an intersection in the road network illustrated in FIG. 3.

FIG. 4B is an explanatory diagram illustrating an example of signal indication at the intersection illustrated in FIG. 4A.

FIG. 5A is an explanatory diagram illustrating a second example of the peripheral configuration of the intersection in the road network illustrated in FIG. 3.

FIG. 5B is an explanatory diagram illustrating an example of signal indication at the intersection illustrated in FIG. 5A.

FIG. 6A is a flowchart illustrating a flow of generating a parameter correction value by a traffic control central device.

FIG. 6B is a flowchart relating to update of a signal control parameter by the traffic control central device.

FIG. 6C is a flowchart relating to display of the signal control parameter and related information by the traffic control central device.

FIG. 7 is a flowchart illustrating an example of a number of times of signal waiting calculation process (ST102) in FIG. 6A.

FIG. 8A is an explanatory diagram illustrating an example of collection information on step ST204 in FIG. 7.

FIG. 8B is an explanatory diagram illustrating an example of number of times of signal waiting calculated in step ST205 in FIG. 7.

FIG. 9 is a flowchart illustrating an example of a blue time adjustment value determination process ST103 in FIG. 6A.

FIG. 10 is a diagram illustrating an example of a relationship between the number of times of signal waiting and a temporary adjustment value.

FIG. 11 is a flowchart illustrating a method of calculating a blue time final adjustment value in a case of three indications in step ST304 in FIG. 9.

FIG. 12 is a flowchart illustrating a modification example of the method of calculating the blue time final adjustment value illustrated in FIG. 11.

FIG. 13 is a flowchart illustrating an example of a blue time adjustment value condition determination process ST104 in FIG. 6A.

FIG. 14 is an explanatory diagram illustrating an example of a parameter correction value generated in step ST603 in FIG. 13.

FIG. 15 is a flowchart illustrating an example of a signal control parameter update process ST105 in FIG. 6B.

FIG. 16 is a flowchart illustrating an example of a control information display process ST106 in FIG. 6C.

FIG. 17A is an explanatory diagram illustrating an example of a history information list displayed in the process of step ST802 in FIG. 16.

FIG. 17B is an explanatory diagram illustrating an example of a parameter correction value information list displayed in the process of step ST802 in FIG. 16.

FIG. 17C is an explanatory diagram illustrating an example of the correction parameter information list displayed in the process of step ST802 in FIG. 16.

FIG. 17D is an explanatory diagram illustrating an example of notification information on a correction parameter displayed in the process of step ST802 in FIG. 16.

FIG. 18 is an overall configuration diagram illustrating a modification example of the signal control system according to the embodiment.

### DESCRIPTION OF EMBODIMENTS

A first invention made to solve the above-described problems is a signal control device including a processor that provides signal control information for controlling a traffic light installed at an intersection, in which the processor calculates number of times of signal waiting of a vehicle in a plurality of vehicle outflow directions at the intersection, and determines an adjustment value of a passage permission time for the signal control information of the traffic light relating to the vehicle outflow direction, based on the number of times of signal waiting.

According to the invention, since a passage permission time relating to a specific outflow direction of a vehicle is adjusted based on number of times of signal waiting of the vehicle, a more appropriate control of traffic light can be performed depending on a continuous change in a traffic situation.

Further, in a second invention, the determination of the adjustment value of the passage permission time is performed at a predetermined cycle.

According to the invention, by appropriately determining a cycle for determining an adjustment value of traffic permission time, it is possible to control a traffic signal more appropriately depending on a continuous change in a traffic situation on various roads.

Further, in a third invention, the number of times of signal waiting is calculated based on a travel time of a target vehicle passing through the intersection.

According to the invention, it is possible to calculate number of times of signal waiting with a simple configuration by using a travel time that can be easily acquired from an on-road communication device or the like or can be easily generated based on information acquired from the on-road communication device or the like.

Further, in a fourth invention, the number of times of signal waiting is calculated based on a difference between the calculated travel time and a reference time set for a travel path of a vehicle relating to the travel time.

According to the invention, by considering reference time corresponding to a travel time, it is possible to calculate number of times of signal waiting with a higher accuracy.

Further, in a fifth invention, the number of times of signal waiting is calculated based on a passage prohibition time of a target vehicle in the vehicle outflow direction.

According to the invention, it is possible to exclude an influence of signal waiting of a vehicle at a passage prohibition time by considering the passage prohibition time (time other than a passage permission time) of the vehicle in a specific vehicle outflow direction.

Further, in a sixth invention, the processor determines whether or not the adjustment value of the passage permission time satisfies a preset permission condition.

According to the invention, it is possible to avoid that an inappropriate passage permission time is set for a traffic light of a control target based on a preset permission condition.

Further, in a seventh invention, the permission condition includes at least one of an upper limit value and a lower limit value of the passage permission time in the signal control information.

According to the invention, it is possible to avoid that an inappropriate passage permission time is set for a traffic signal of a control target based on a simple condition relating to a passage permission time.

Further, in an eighth invention, the processor corrects the adjustment value of the passage permission time such that the permission condition is satisfied in a case where the adjustment value of the passage permission time does not satisfy the permission condition.

According to the invention, even in a case where an adjustment value of a passage permission time does not satisfy a permission condition, it is possible to set an appropriate adjustment value of the passage permission time within a range satisfying the permission condition.

Further, a ninth invention further includes a backup information storage that stores information of the passage permission time before the adjustment value of the passage permission time is applied.

According to the invention, even in a case where an adjustment value of a passage permission time is not valid, a traffic manager can easily change again an adjusted passage permission time to a value before the adjustment.

Further, in a tenth invention, the processor calculates number of times of signal waiting of a vehicle for each of the plurality of vehicle outflow directions to which different indications are applied in the traffic light, and determines the adjustment value of the passage permission time for each of the vehicle outflow directions, based on a plurality of the number of times of signal waiting.

According to the invention, it is possible to control a traffic light depending on a continuous change in a traffic situation while suppressing an imbalance with traffic in another vehicle outflow direction due to adjustment of a passage permission time in a specific vehicle outflow direction.

Further, in an eleventh invention, the plurality of vehicle outflow directions include a plurality of outflow directions relating to vehicles whose inflow directions to the intersection are the same as each other.

According to the invention, it is possible to control a traffic light depending on a continuous change in a traffic situation for a vehicle having the same inflow direction to an intersection, and a combination of signal indication that can be adjusted by the present method increases.

Further, a twelfth invention further includes a display unit that displays an adjustment value of the determined passage permission time.

According to the invention, a traffic manager can easily determine whether or not an adjustment value of a passage permission time determined by a signal control device is appropriate.

Further, a thirteenth invention includes the signal control device according to any one of the first invention to the twelfth invention, and an on-road communication device that acquires information on a travel time of a vehicle passing through the intersection.

According to the invention, since a passage permission time relating to a specific outflow direction of a vehicle is adjusted based on number of times of signal waiting of the vehicle, a more appropriate control of a traffic light can be performed depending on a continuous change in a traffic situation.

Further, a fourteenth invention is a signal control method of providing signal control information for controlling traffic light installed at an intersection including calculating number of times of signal waiting of a vehicle for a plurality of vehicle outflow directions at the intersection, and determining an adjustment value of a passage permission time for the signal control information of the traffic light relating to the vehicle outflow direction, based on the number of times of signal waiting.

According to the invention, since a passage permission time relating to a specific outflow direction of a vehicle is adjusted based on number of times of signal waiting of the vehicle, a more appropriate control of a traffic light can be performed depending on a continuous change in a traffic situation.

Further, a fifteenth invention is a signal control program for causing a computer to perform a process of providing signal control information for controlling a traffic light installed at an intersection, and causes the computer to perform a step of calculating number of times of signal waiting of a vehicle for a plurality of vehicle outflow directions at the intersection, and a step of determining an adjustment value of a passage permission time for the signal control information of the traffic light relating to the vehicle outflow direction, based on the number of times of signal waiting.

According to the invention, since a passage permission time relating to a specific outflow direction of a vehicle is adjusted based on number of times of signal waiting of the vehicle, a more appropriate control of a traffic light can be performed depending on a continuous change in a traffic situation.

Hereinafter, embodiments of the present disclosure will be described with reference to the drawings.

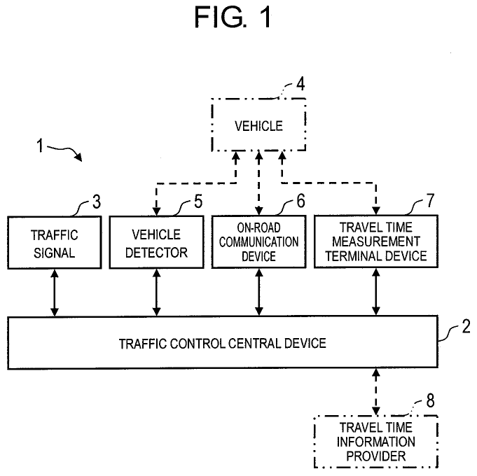

FIG. 1 is an overall configuration diagram of signal control system 1 according to the present embodiment. Signal control system 1 mainly includes traffic control central device (signal control device) 2, traffic signal 3 installed at an intersection or the like, vehicle detector 5 for detecting vehicle 4 passing on a road, on-road communication device 6 communicating with an in-vehicle device mounted on vehicle 4, and travel time measurement terminal device 7 for measuring a travel time of vehicle 4 (time required for vehicle 4 traveling on a road to reach from one point to another point).

Signal control system 1 can be realized as an additional function of an existing traffic control system that manages traffic in a predetermined region. Alternatively, signal control system 1 may be configured to perform a traffic signal control in cooperation with the existing traffic control system. Further, the signal control by signal control system 1 can be applied to a known constant cycle control, traffic adaptation control, and the like.

Although not illustrated in FIG. 1, in practice, signal control system 1 is provided with a plurality of traffic lights 3, vehicle detectors 5, on-road communication devices 6, and travel time measurement terminal devices 7. Further, signal control system 1 can appropriately acquire travel time information of vehicle 4 traveling on a management target road from predetermined travel time information provider 8 (or an information database owned by a travel time information provider) through network communication, a storage medium, or the like.

Traffic control central device 2 is installed in a traffic control center that performs a traffic control for each region, and performs a traffic signal control for traffic light 3 based on vehicle detector information collected from vehicle detector 5 and control setting information including a signal control parameter. Traffic control central device 2 can generate traffic information on a traffic jam section and the like based on, for example, traffic jam section information generated from the vehicle detector information and travel time information (information including a travel time) generated from the information collected from on-road communication device 6 and travel time measurement terminal device 7, thereby, also being capable of providing the traffic information to a driver of vehicle 4.

Traffic light 3 is a known device that indicates permission of passage (progress) and prohibition of passage (stop) of vehicle 4 traveling on a road, and is installed particularly at an intersection here. In traffic control central device 2, after a signal control parameter of a next cycle is determined from the vehicle detector information and the control setting information, signal control information (signal control command) generated based on the signal control parameter is transmitted to traffic light 3. Thereby, in traffic light 3, a control of a signal lamp based on the signal control information is realized. The signal control parameter includes a cycle length, a split, and an offset, which are factors for determining traffic signal display timing. Further, although not illustrated, traffic light 3 includes not only a signal lamp that displays a predetermined lamp color (here, red, blue (green), yellow), but also a signal controller that controls the signal lamp based on the signal control information.

Vehicle detector 5 is a known traffic information collection device that acquires vehicle detector information necessary for a normal traffic management such as a traffic volume (number of passing vehicles per unit time) and a time occupancy rate (ratio of time during which a point on a road is occupied by a vehicle within the unit time).

On-road communication device 6 includes optical beacons that are installed at a plurality of points on the road and detect vehicles 4 passing therethrough with light (near infrared ray) and has a function of detecting presence of vehicle 4 and a bidirectional communication function with vehicle 4.

In a case where vehicle 4 is equipped with an in-vehicle device corresponding to the optical beacon, on-road communication device 6 can acquire a travel history from the in-vehicle device in addition to the vehicle identification information (vehicle ID) or the vehicle identification information. By acquiring the vehicle identification information from on-road communication device 6, traffic control central device 2 can generate travel time information of the vehicle based on a time difference that the same vehicle passed by on-road communication devices 6 at a plurality of points. Further, traffic control central device 2 can generate travel time information from a difference between entry time and exit time with respect to a section based on the travel history by acquiring the vehicle identification information and the travel history from on-road communication device 6.

As long as at least traffic control central device 2 can acquire the travel time information (or information necessary for calculating a travel time) of vehicle 4, on-road communication device 6 is not limited to the optical beacon and can also use another types of device (for example, ITS spot).

Travel time measurement terminal device 7 images license plates of vehicles passing by using cameras installed at a plurality of points on the road and provides traffic control central device 2 with vehicle identification information and time information obtained by reading information such as numbers of a license plate through an image process as information for calculating the travel time of the vehicle. Thereby, traffic control central device 2 can generate travel time information of the vehicle based on a time difference that the same vehicle passed by the travel time measurement terminal devices 7 at the plurality of points.

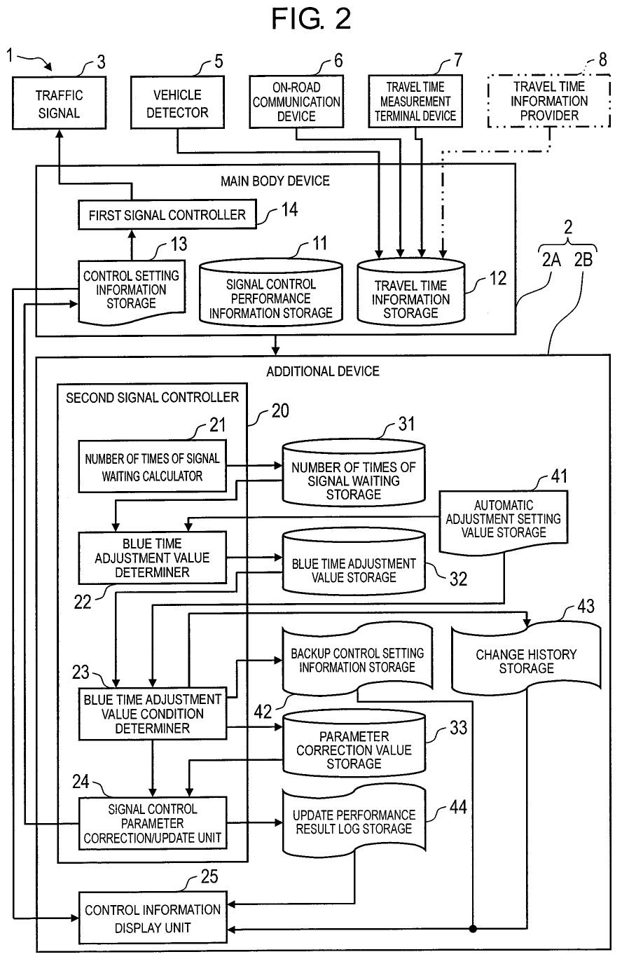

FIG. 2 is a functional block diagram illustrating details of signal control system 1 illustrated in FIG. 1. Traffic control central device 2 includes main body device 2A that performs an existing function relating to a traffic management, and additional device 2B that is attached to main body device 2A and performs a new function relating to the traffic management. With such a structure, a new function can be added to traffic control central apparatus 2 while using the existing configuration for traffic control central apparatus 2. Main body device 2A and additional device 2B do not need to be juxtaposed and are arranged in, for example, a remote place, and a configuration is also possible in which communication is established with each other via a known communication network.

Main body device 2A includes signal control performance information storage 11 that stores signal control performance information including a signal control parameter used for a past signal control, travel time information storage 12 that stores a plurality of pieces of travel time information relating to each vehicle obtained (or calculated from information obtained from at least one of them) from at least one of on-road communication device 6, travel time measurement terminal device 7, and travel time information provider 8, control setting information storage 13 that stores control setting information including a signal control parameter, and first signal controller 14 that performs a signal control relating to a traffic management. Main body device 2A can appropriately store information on an intersection configuring a road network necessary for the traffic management and a connection form of each road section, information on the number of lanes in each road section, and the like.

Main body device 2A is configured with a computer having known hardware, and first signal controller 14 includes one or more processors. At least a part of the respective functions of main body device 2A performed by first signal controller 14 is realized by executing a predetermined signal control program using the processor. Further, main body device 2A includes a storage and a memory for storing various types of information and data, an input device in which a traffic manager (manager of signal control system 1) can perform setting input and the like, a display device that displays various information for the traffic manager, and the like.

Main body device 2A performs a process of generating signal control information based on the control setting information, the vehicle sensor information, and the like, in the same manner as a method of a related art. However, as will be described in detail below, the control setting information used in main body device 2A is appropriately updated by acquiring information (that is, updated signal control parameter) for adjusting blue time (usually, permission time of vehicle passage when blue light or green light is displayed, which is equivalent to split of a signal control parameter) from additional device 2B.

Additional device 2B includes second signal controller 20 that performs a process (hereinafter, referred to as a “signal control parameter adjustment process”) of adjusting the blue time according to a continuous change in a traffic situation on a target road. Information such as the travel time information and the signal control performance information necessary for additional device 2B to perform the signal control parameter adjustment process can be appropriately acquired from main body device 2A.

Second signal controller 20 includes number of times of signal waiting calculator 21 that calculates number of times of signal waiting of each vehicle for a vehicle outflow direction (hereinafter referred to as a “specific outflow direction”) becoming a plurality of control targets at an intersection, blue time adjustment value determiner 22 that determines the blue time adjustment value for the current signal control parameter of traffic light 3 relating to a specific outflow direction based on the calculated number of times of signal waiting, blue time adjustment value condition determiner 23 that determines whether or not the determined blue time adjustment value satisfies a predetermined permission condition of the current signal control parameter and generates an adjustment value (hereinafter, referred to as a “parameter correction value”) of the blue time adjusted to satisfy the permission condition, signal control parameter correction/update unit 24 that updates the signal control parameter based on a parameter correction value, and control information display unit 25 that displays the updated signal control parameter and related information.

Here, the number of times of signal waiting of a vehicle calculated by number of times of signal waiting calculator 21 is an estimated value assuming that a case where it switches to a red signal again without passing through the intersection is counted as one time regardless of becoming a blue signal (lamp color of traffic light 3 is blue) after vehicle 4 reaches the intersection and decelerates or stops. However, a method of calculating the number of times of signal waiting of a vehicle is not limited to illustration herein, and the number of times of signal waiting may be calculated by another method (for example, image process based on an imaged image obtained by imaging a vehicle passing through an intersection with a camera) as necessary. Further, correction (that is, generation of the parameter correction value) of the blue time adjustment value is not necessarily essential and can be omitted as appropriate.

Further, additional device 2B includes number of times of signal waiting storage 31 in which the number of times of signal waiting calculated by number of times of signal waiting calculator 21 is stored, blue time adjustment value storage 32 in which the blue time adjustment value determined by blue time adjustment value determiner 22 is stored, and parameter correction value storage 33 in which a parameter correction value generated by blue time adjustment value condition determiner 23 is stored.

Furthermore, additional device 2B includes automatic adjustment setting value storage 41 that stores information on a temporary adjustment value used for a blue time adjustment value determination process by blue time adjustment value determiner 22 which will be described in detail below, information on a permission condition used for the blue time adjustment value condition determination process by blue time adjustment value condition determiner 23, and the like, backup control setting information storage (backup information storage) 42 that stores control setting information (or a signal control parameter) backed up by blue time adjustment value condition determiner 23, change history storage 43 that stores a change history of the parameter correction value by blue time adjustment value condition determiner 23, and update performance result log storage 44 that stores a log of an update performance result by signal control parameter correction/update unit 24.

Although details will be described below, additional device 2B performs a process of generating a blue time adjustment value (including the corrected blue time adjustment value) based on the number of times of signal waiting, and thereafter, updates the signal control parameter based on the blue time adjustment value. The signal control parameter updated by additional device 2B is appropriately transmitted to main body device 2A.

Additional device 2B is configured with a computer having known hardware in the same manner as main body device 2A, and second signal controller 20 described above includes one or more processors. At least a part of the respective functions of additional device 2B performed by second signal controller 20 can be realized by executing a predetermined signal control program using the processor. Further, in the same manner as main body device 2A, additional device 2B can be provided with a storage, a memory, an input device, a display device configuring control information display unit 25, and the like. A processor of second signal controller 20 can perform a necessary process in cooperation with a processor of first signal controller 14 described above.

In the present embodiment, a configuration is provided in which additional device 2B is attached to main body device 2A, but additional device 2B is not necessarily realized as hardware, and can also be realized as a part of a function of a signal control program executed by, for example, first signal controller 14 of main body device 2A. Thereby, it is possible to realize signal control system 1 having the same function as above-described additional device 2B, without adding new hardware to traffic control central device 2.

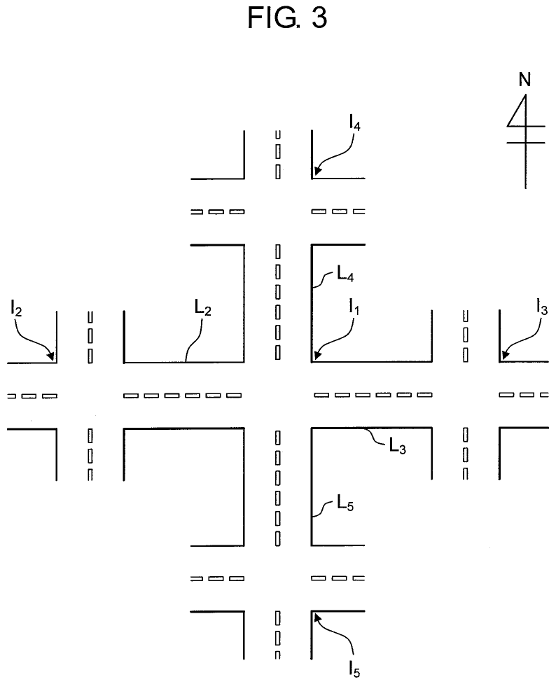

FIG. 3 is an explanatory diagram illustrating an example of a road network in which traffic light 3 to which signal control system 1 is applied is installed. In the present embodiment, a traffic light (not illustrated) installed at intersection I₁ where two predetermined roads in the road network are orthogonal to each other will be described. Intersection I₁ is connected to road section (link) L₂ between the intersection I₂ adjacent to the west and intersection I₁, road section L₃ between intersection I₃ adjacent to the east and intersection I₁, road section L₄ between intersection I₄ adjacent to the north and intersection I₁, and road section L₅ between intersection I₅ adjacent to the south and intersection I₁, respectively. A form of the intersections of the road network where traffic light 3 to which signal control system 1 is applied is installed can be changed variously without being limited to what is illustrated here. Further, on-road communication device 6 and travel time measurement terminal device 7 (both are not illustrated) are installed at predetermined intervals in appropriate places of respective road sections L₂ to L₅.

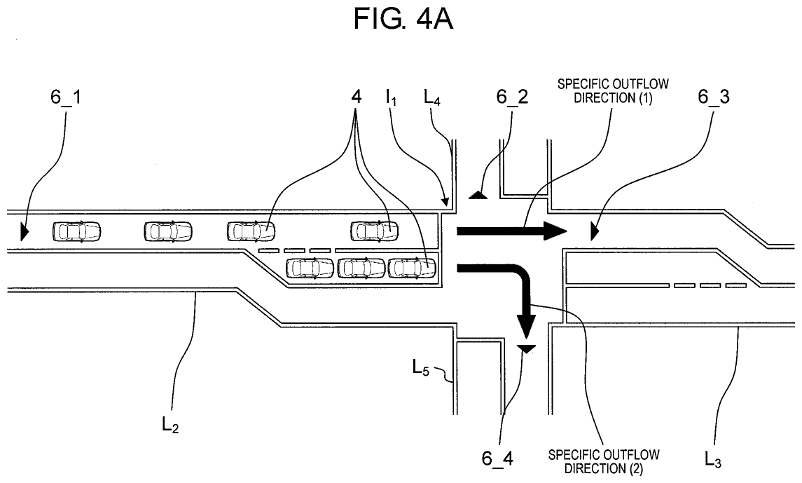

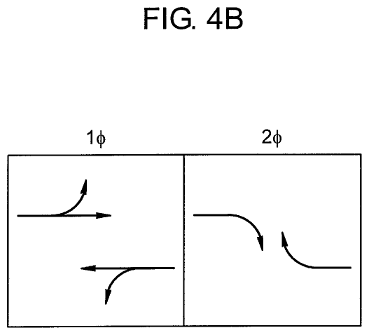

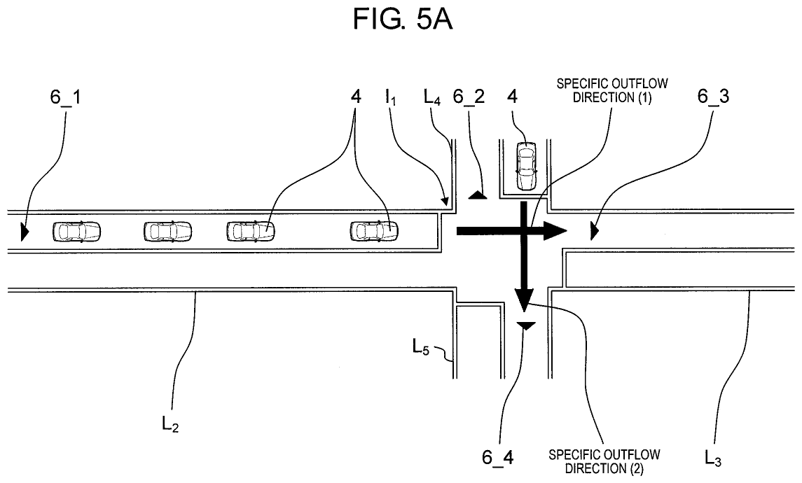

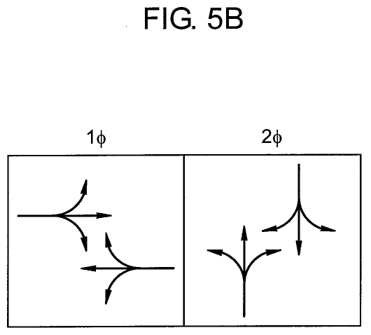

FIGS. 4A and 5A are explanatory diagrams illustrating first and second examples of a peripheral configuration of intersection I₁ in the road network illustrated in FIG. 3, respectively, and FIGS. 4B and 5B are explanatory diagrams illustrating an example of signal indication in intersection illustrated in FIGS. 4A and 5A, respectively.

For example, as illustrated in FIG. 4A, signal control system 1 can perform the signal control parameter adjustment process based on number of times of signal waiting of each vehicle 4 with respect to vehicle 4 flowing into intersection I₁ from road section L₂, in a case where the vehicle travels straight in a direction (specific outflow direction (1)) of road section L₃ as a specific outflow direction, and in a case where the vehicle turns right in a direction (specific outflow direction (2)) of road section L₅ as another specific outflow direction.

In the example illustrated in FIG. 4A, it is assumed that specific outflow directions (1) and (2) which are control targets relate to vehicle 4 which flow into (that is, assumed that an inflow direction to intersection I₁ is the same) the intersection I₁ from road section L₂. Further, signal indication relating to traffic of vehicle 4 are two indications configured by signal indication 1Φ and signal indication 2Φ illustrated in FIG. 4B such that a right of passage is given to each of a straight travel, a left turn, and a right turn. The signal indication at intersection I₁ becomes more indications (for example, three indications) when including an intersection road side including road sections L₃ and L₅, but here, an example is illustrated in which an adjustment target is two indications of all signal indications (signal indication 1Φ and signal indication 2Φ).

As described above, signal control system 1 can control more appropriate traffic lights depending on a continuous change in traffic situation by adjusting the blue time relating to the specific outflow direction by using the number of times of signal waiting of a vehicle as an index of whether or not a signal control is properly performed for the specific outflow direction of the vehicle. Particularly, as illustrated in FIG. 4A, signal control system 1 can control the traffic light depending on the continuous change in traffic situation for vehicle 4 having the same inflow direction to intersection I₁, thereby, a combination of signal indications that can be adjusted by the present technique increases.

Further, FIG. 4A illustrates a disposition example of on-road communication device 6. For example, traffic control central device 2 can generate travel time information of specific outflow direction (1) from the time when vehicle 4 passes by on-road communication device 6_1 disposed on an upstream side of road section L₂ and reaches on-road communication device 6_3 disposed in road section L₃. Further, traffic control central device 2 can generate travel time information of specific outflow direction (2) from the time when vehicle 4 passes by on-road communication device 6_1 and reaches on-road communication device 6_4 disposed in road section L₅. Further, traffic control central device 2 can generates travel time information of the vehicle outflow direction regarding a left turn from the time when vehicle 4 passes by on-road communication device 6_1 and reaches on-road communication device 6_2 disposed in road section L₄. Traffic control central device 2 can generate the travel time information even in a configuration illustrated in FIG. 5A which will be described below.

Further, for example, as illustrated in FIG. 5A, signal control system 1 can perform the signal control parameter adjustment process based on the number of times of signal waiting of each vehicle 4 with respect to vehicle 4 flowing into intersection I₁ from road section L₂, in a case where the vehicle 4 travels straight in a direction (specific outflow direction (1)) of road section L₃, and in a case where the vehicle travels straight in a direction (specific outflow direction (2)) of road section L₅ with respect to vehicle 4 flowing into intersection I₁ from road section L₄.

In the example illustrated in FIG. 5A, it is assumed that specific outflow directions (1) and (2) which are control targets flow into intersection I₁ from different road sections L₂ and L₄, respectively. Further, signal indications relating to passage of vehicles 4 are two indications configured by signal indication 1Φ and signal indication 2Φ illustrated in FIG. 5B such that a right of passage is given simultaneously to a straight travel, a left turn, and a right turn.

A traffic manager can set a plurality of desirable specific outflow directions according to the signal indication without being limited to the above-described examples. By setting a plurality of directions as specific outflow directions and performing the signal control parameter adjustment process, it is possible to avoid imbalance (for example, traffic jam and congestion in one outflow direction are reduced by adjusting the blue time, resulting in new traffic jam and congestion in other outflow directions) between traffic flows with other outflow directions by adjusting the blue time focusing only on one outflow direction. Further, the specific outflow direction is not limited to the above-described example, and three or more directions having different signal indications can be set therefor.

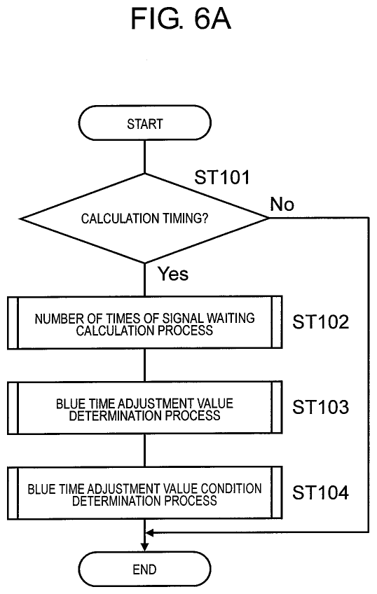

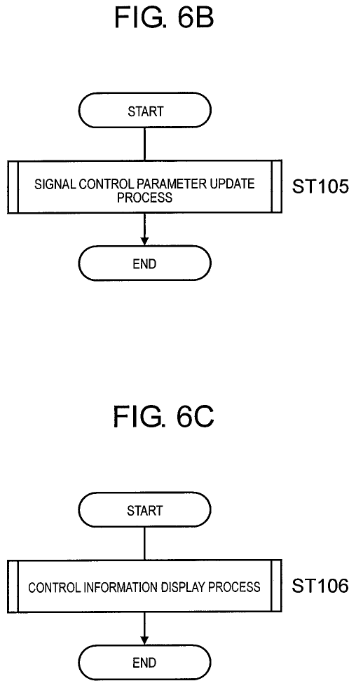

FIGS. 6A to 6C relate to the signal control parameter adjustment process by traffic control central device 2 (additional device 2B). FIGS. 6A to 6C are flowcharts illustrating a flow of the signal control parameter adjustment process by traffic control central apparatus 2 (additional device 2B). Here, FIG. 6A is a flowchart illustrating a flow of generating the parameter correction value, FIG. 6B is a flowchart regarding update of the signal control parameter based on the parameter correction value, and FIG. 6C is a flowchart regarding displays of a signal control parameter and related information.

Regarding the signal control parameter adjustment process, as illustrated in FIG. 6A, additional device 2B sequentially performs a number of times of signal waiting calculation process (ST102) of calculating number of times of signal waiting of a vehicle relating to the specific outflow direction if it is calculation timing of the number of times of signal waiting (ST101: Yes), a blue time adjustment value determination process (ST103) of determining a blue time adjustment value for the current signal control parameter of traffic light 3 based on the number of times of signal waiting calculated in step ST102, and the blue time adjustment value condition determination process (ST104) of determining whether or not the blue time adjustment value determined in step ST103 satisfies a predetermined permission condition for the current signal control parameter and generating a parameter correction value (corrected blue time adjustment value) that satisfies a corresponding permission condition. Here, calculation timing of the number of times of signal waiting can be set as a predetermined cycle (for example, weekly or monthly), but is not limited to this, and can also be set based on the number of pieces of accumulated data (or an accumulation period) relating to collection information or the like. The calculation timing of the number of times of signal waiting can also be set as a predetermined time. In that case, the set time does not necessarily have to be a constant interval.

As described above, by providing a configuration of determining whether or not the preset permission condition is satisfied for the blue time of the signal control parameter, it is possible to avoid that an inappropriate blue time (furthermore signal control information) for the traffic light of a control target is set based on a preset permission condition.

Further, as illustrated in FIG. 6B, additional device 2B performs a signal control parameter update process (ST105) of updating the signal control parameter based on the parameter correction value generated as described above. The updated signal control parameter is appropriately transmitted to main body device 2A.

Further, as illustrated in FIG. 6C, if a display request is received from a traffic manager, additional device 2B performs a control information display process (ST106) of displaying the signal control parameter updated as described above and the related information thereof.

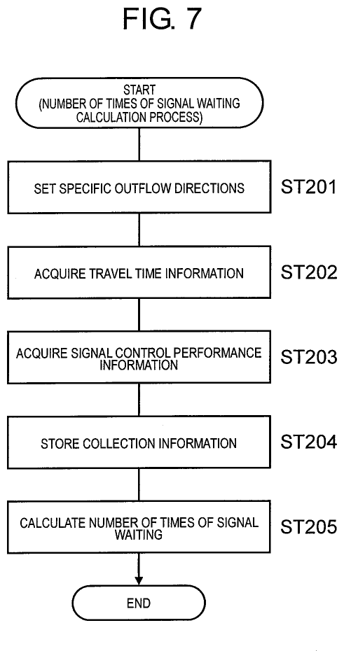

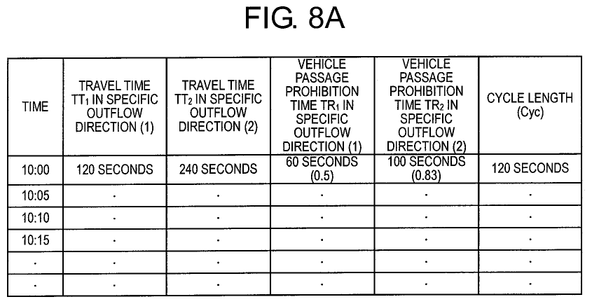

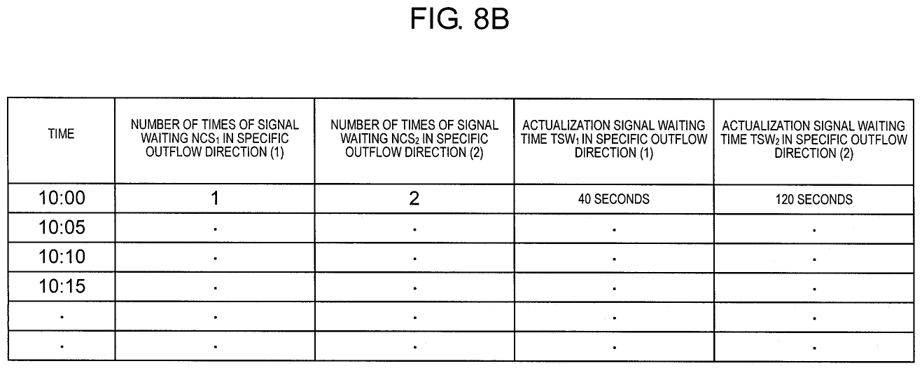

FIG. 7 is a flowchart illustrating an example of the number of times of signal waiting calculation process (ST102) in FIG. 6A, FIG. 8A is an explanatory diagram illustrating an example of the collection information on step ST204 in FIG. 7, and FIG. 8B is an explanatory diagram illustrating an example of the number of times of signal waiting calculated in step ST205 in FIG. 7.

As illustrated in FIG. 7, in the number of times of signal waiting calculation process, additional device 2B first sets a plurality of specific outflow directions in relation to traffic of vehicle 4 at intersection I₁ where traffic light 3 of a control target is installed (ST201). The specific outflow direction can be appropriately set, for example, as illustrated in FIGS. 4A and 5A described above. A traffic manager can input the specific outflow direction through an input device (not illustrated) attached to traffic control central device 2, or can also store previously the preset specific outflow direction in a storage, a memory, or the like provided in traffic control central device 2.

Next, additional device 2B acquires travel time information from main body device 2A (ST202). Subsequently, additional device 2B acquires signal control performance information (or control setting information) for a period corresponding to a target period of the travel time information acquired in step ST202 from main body device 2A likewise (ST203). For the travel time (representative value) in the target period of the travel time information, for example, an average value or a percentile value of the period can be used.

Next, additional device 2B performs a collection process of each piece of information acquired in steps ST202 and ST203 and stores the result as collection information (ST204). In the collection process, vehicle passage prohibition time (time when passage of a vehicle is prohibited for corresponding signal indication (or ratio to cycle length)) for the specific outflow direction from signal control performance information (or control setting information), a cycle length, and the like are calculated and stored as the collection information together with the travel time information. The collection information can be stored in number of times of signal waiting storage 31 as related information of the number of times of signal waiting which will be described below.

In the collection information, for example, as illustrated in FIG. 8A, each piece of data is collected at a predetermined cycle (every 5 minutes from 10:00 in FIG. 8A). Here, travel time TT₁ in specific outflow direction (1), travel time TT₂ in specific outflow direction (2), vehicle passage prohibition time TR₁ in specific outflow direction (1), and vehicle passage prohibition time TR₂ in specific outflow direction (2), data of cycle length Cyc, and the like are sequentially recorded om the collection information.

Travel time TT₁ (the same applies to travel time TT₂) is, for example, time (an average value and a percentile value of the travel time for a plurality of vehicles 4) required for vehicle 4 to reach a predetermined point on a road after passing intersection I₁ in specific outflow direction (1) from a predetermined point on the road before vehicle 4 reaches intersection I₁. Further, numerical values in parentheses in vehicle passage prohibition time TR₁ in specific outflow direction (1) and vehicle passage prohibition time TR₂ in specific outflow direction (2) indicate a ratio to a cycle length in a case where the cycle length is set to 1. In the collection information, a date type (weekday, Saturday, holiday) or a day type (Sunday, Monday, Tuesday, Wednesday, Thursday, Friday, Saturday) may be used as a collection category.

Referring back to FIG. 7, subsequently, additional device 2B calculates the number of times of signal waiting (ST205).

More specifically, in the calculation of the number of times of signal waiting in step ST206, first, actualization signal waiting time TSW_{j,t} in specific outflow direction j at time t is calculated based on Equation (1.1).

[Equation 1]

TSW_{j,t}=(TT_{j,t}−TB_{j,t})−TR_{j,t} (1.1)

However,

TT_{j,t}: Travel time in specific outflow direction j

TB_{j,t}: Travel time reference value in specific outflow direction j

TR_{j,t}: vehicle passage prohibition time in specific outflow direction j

The travel time reference value (reference time set for a travel path of a vehicle relating to travel time TT_{j,t}) in specific outflow direction j can be set appropriately by a traffic manager. Further, a value obtained by dividing a predetermined link length (length of a predetermined road section until reaching specific outflow direction j) by a vehicle regulation speed may be used as the travel time reference value.

Next, number of times of signal waiting NCS_{j,t} in specific outflow direction j at time t can be calculated by using actualization signal waiting time TSW_{j,t} and cycle length Cyc, based on Equation (1.2).

$$\begin{matrix}[ Equation 2 ] & \\ {NCS}_{j , t} = \{ \begin{matrix}\frac{{TSW}_{j , t}}{Cyc} + 1 & {TSW}_{j , t} > 0 \\ 0 & {TSW}_{j , t} \leq 0\end{matrix} & ( 1.2 )\end{matrix}$$

Calculated number of times of signal waiting NCS_{j,t} and actualization signal waiting time TSW_{j,t} are stored in number of times of signal waiting storage 31 together with corresponding collection information in a predetermined period (every 5 minutes from 10:00 in FIG. 8B) corresponding to the collection information, for example, as illustrated in FIG. 8B.

As described above, in signal control system 1, the number of times of signal waiting NCS_{j,t} can be easily obtained from existing on-road communication device 6, travel time measurement terminal device 7, and the like, or is calculated based on travel time TT_{j,t} that can be easily generated based on information acquired from on-road communication device 6 and travel time measurement terminal device 7, thereby, being calculated with a simple configuration. Further, since a difference (see Equation (1.1)) between travel time TT_{j,t} and travel time reference value TB_{j,t} is used to calculate number of times of signal waiting NCS_{j,t}, the number of times of signal waiting can be calculated with a higher accuracy. Furthermore, since passage prohibition time TR_{j,t} (see Equation (1.1)) is used to calculate number of times of signal waiting NCS_{j,t}, it is possible to exclude an influence of signal waiting of a vehicle in the passage prohibition time.

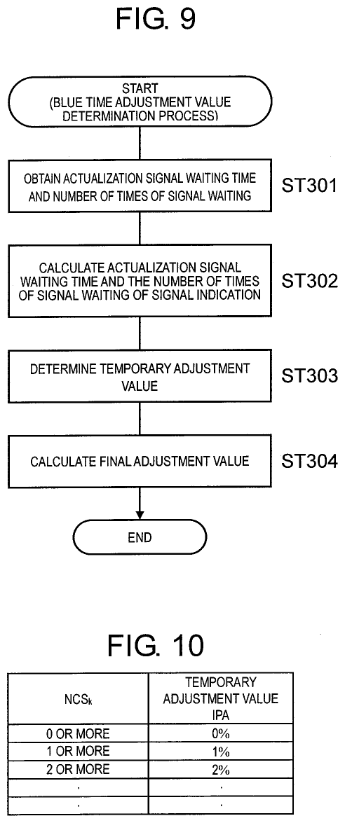

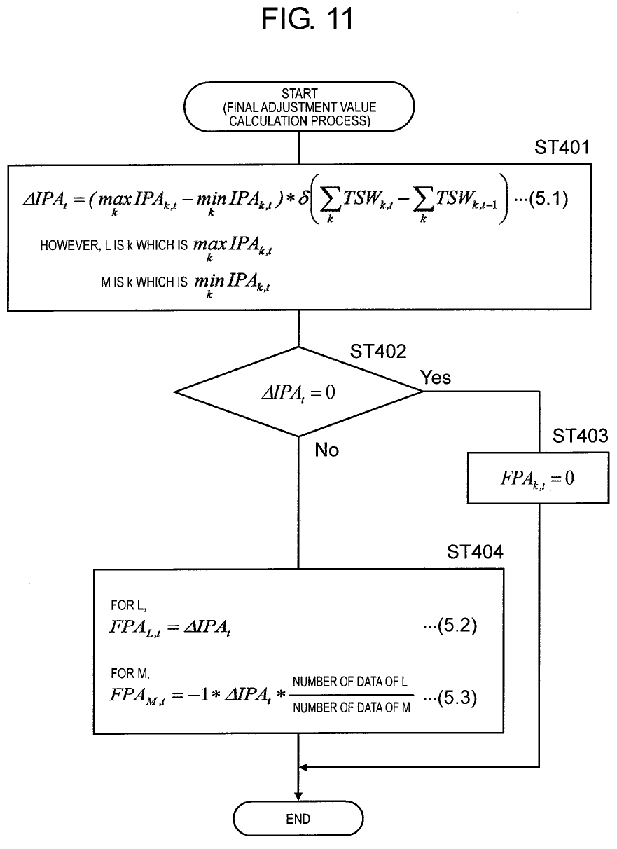

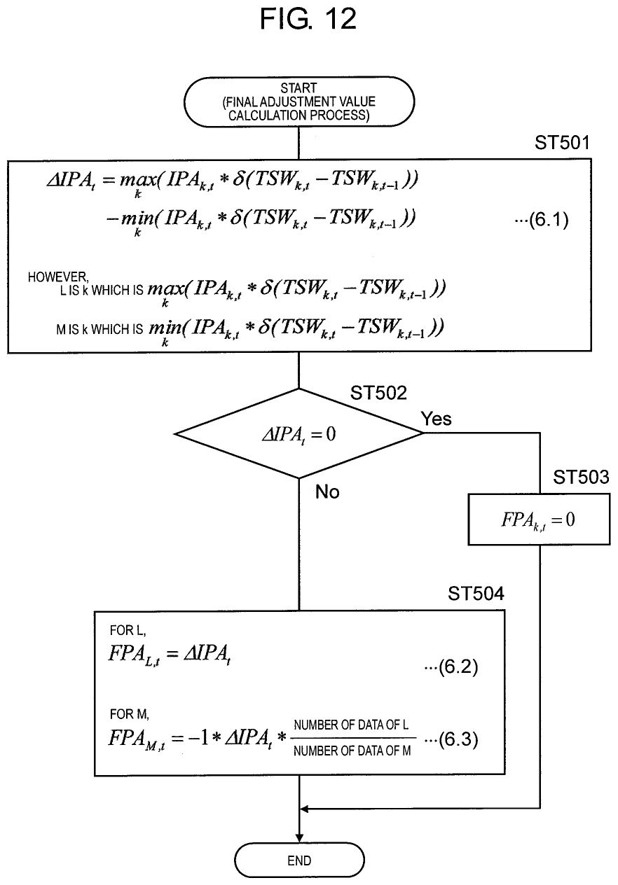

FIG. 9 is a flowchart illustrating an example of the blue time adjustment value determination process (ST103) in FIG. 6A, FIG. 10 is a table illustrating a relationship between the number of times of signal waiting (maximum value) and the temporary adjustment value relating to a predetermined signal indication (specific outflow direction), FIG. 11 is a flowchart illustrating a method of calculating the blue time final adjustment value in a case of three indications in step ST304 in FIG. 9, and FIG. 12 is a flowchart illustrating a modification example of the method of calculating the blue time final adjustment value illustrated in FIG. 11.

As illustrated in FIG. 9, in the blue time adjustment value determination process, first, additional device 2B obtains actualization signal waiting time TSW_{j,t} and number of times of signal waiting NCS_{j,t} calculated by the number of times of signal waiting calculation process described above (ST301). Subsequently, in order to calculate the actualization waiting time and the number of times of signal waiting of signal indication k, each of maximum value TSW_{k,t} of actualization signal waiting time and maximum value NCS_{k,t} of number of times of signal waiting of signal indication k corresponding to the specific outflow direction are calculated based on Equation (2.1) and Equation (2.2) (ST302). In this way, it is possible to appropriately reduce traffic jam and congestion by using a maximum value corresponding to a greater degree of congestion in relation to the actualization waiting time and the number of times of signal waiting.

[Equation 3]

TSW_{k,t}=maxⱼ(TSW_{j,k,t}) (2.1)

[Equation 4]

NCS_{k,t}=maxⱼ(NCS_{j,k,t}) (2.2)

However,

TSW_{j,k,t}: actualization waiting time in specific outflow direction j in a case where signal indication thereof is k

NCS_{j,k,t}: number of times of signal waiting in specific outflow direction j in a case where the signal indication is k

Next, by using maximum value NCS_{k,t} of the number of times of signal waiting of signal indication k, for example, temporary adjustment value IPA is determined from a table illustrating a relationship between the maximum value of the number of times of signal waiting illustrated in FIG. 10 and temporary adjustment value IPA relating to signal indication k (ST303). In FIG. 10, temporary adjustment value IPA is illustrated as a ratio (%) to cycle length Cyc.

Next, each of blue time final adjustment value FPA_{1,t} of signal indication 10 (k=1) and blue time final adjustment value FPA_{2,t} of signal indication 21 (k=2) is calculated based on Equation (3.1) and Equation (3.2) (ST304). Here, δ(x) is obtained from Equation (3.3) and is an index indicating whether or not the actualization signal waiting time relating to a target signal indication tends to increase. That is, in a case where the actualization signal waiting time does not tend to increase, δ(x)=0, and final adjustment value FPA_{1,t} (or FPA_{2,t}) also becomes 0 (that is, the blue time adjustment value is not set practically.). Measures against traffic jam are expected to be more effective by being less effective in a case where congestion tends to decrease and by preventing traffic jam in a case where the congestion is increasing. Thus, as in the present method, it is possible to prevent the traffic jam from occurring with respect to the indication by making an adjustment by paying attention to a case where the actualization signal waiting time increases for the indication.

$$\begin{matrix} [ Equation 5 ] & \\ {FPA}_{1 , t} = {IPA}_{1 , t} * δ ( {TSW}_{1 , t } - {TSW}_{1 , t - 1} ) - {IPA}_{2 , t} * δ ( {TSW}_{2 , t} - {TSW}_{2 , t - 1} ) & ( 3.1 ) \\ [ Equation 6 ] & \\ {FPA}_{2 , t} = {IPA}_{2 , t} * δ ( {TSW}_{2 , t } - {TSW}_{2 , t - 1} ) - {IPA}_{1 , t} * δ ( {TSW}_{1 , t} - {TSW}_{1 , t - 1} ) & ( 3.2 ) \\ [ Equation 7 ] & \\ δ ( x ) \{ \begin{matrix}= 1 ( x > 0 ) \\ = 0 ( x \leq 0 )\end{matrix} & ( 3.3 )\end{matrix}$$

Further, in step ST304, each of blue time final adjustment value FPA_{1,t} of signal indication 1Φ and blue time final adjustment value FPA_{2,t} of signal indication 2Φ can be calculated based on Equation (4.1) and Equation (4.2) instead of Equation (3.1) and Equation (3.2). By performing an adjustment only in a case where the actualization signal waiting time of all intersections increases in consideration of situations of all intersections in the same manner as the present method, it is possible to prevent traffic jam from occurring in all intersections.

$$\begin{matrix}[ Equation 8 ] & \\ {FPA}_{1 , t} = ( {IPA}_{1 , t} - {IPA}_{2 , t} ) * δ ( {\sum }_{k} {TSW}_{k , t} - {\sum }_{k} {TSW}_{k , t - 1} ) & ( 4.1 ) \\ [ Equation 9 ] & \\ {FPA}_{2 , t} = ( {IPA}_{2 , t} - {IPA}_{1 , t} ) * δ ( {\sum }_{k} {TSW}_{k , t} - {\sum }_{k} {TSW}_{k , t - 1} ) & ( 4.2 )\end{matrix}$$

Further, although the above-described examples describe calculation of the blue time final adjustment value in a case of two indications (for example, between two indications of a first indication and a third indication among intersections of three indications), the blue time final adjustment value can be calculated also for three or more indications likewise.

In a case of three or more indications, for example, as illustrated in FIG. 11, a preprocess for obtaining ΔIPAₜ is performed based on Equation (5.1) (ST401). Subsequently, in a case where the calculated ΔIPAₜ=0 (ST402: Yes), blue time final adjustment value FPA_{k,t}=0 is obtained (that is, a blue time adjustment value is not substantially set) (ST403).

Meanwhile, in a case where the calculated ΔIPAₜ is not 0 (ST402: No), increased blue time final adjustment value FPA_{L,t} is calculated for indication L on the basis of Equation (5.2), and decreased blue time final adjustment value FPA_{M,t} is calculated for indication M on the basis of Equation (5.3) (ST404).

Finally, the blue time final adjustment value may be adjusted based on Equation (5.4). Here, n is a coefficient that can be changed by a traffic manager to adjust the blue time final adjustment value.

[Equation 10]

FPA_{k,t}=n*FPA_{k,t} (5.4)

Further, for example, as illustrated in FIG. 12, the blue time final adjustment value can also be calculated by a generalized equation in a case of three or more indications.

In FIG. 12, a preprocess for obtaining ΔIPAₜ is performed based on Equation (6.1) (ST501). Subsequently, in a case where the calculated ΔIPAₜ=0 (ST502: Yes), blue time final adjustment value FPA_{k,t}=0.

Meanwhile, in a case where the calculated ΔIPAₜ is not 0 (ST502: No), increased blue time final adjustment value FPA_{L,t} is calculated for indication L based on Equation (6.2), and decreased blue time final adjustment value FPA_{M,t} is calculated for indication M based on Equation (6.3) (ST504). Calculated final adjustment values FPA_{L,t} and FPA_{M,t} are stored in blue time adjustment value storage 32.

The calculation of blue time adjustment value (blue time final adjustment value) can be performed in a predetermined cycle (for example, weekly or monthly) previously set according to the number of times of signal waiting. Thereby, by appropriately determining the cycle, it is possible to control the traffic light more appropriately depending on a continuous change in traffic situations on various roads. Calculation of the blue time adjustment value can be calculated at a plurality of predetermined times. In that case, the time for calculating the blue time adjustment value does not necessarily have to be a constant interval.

Further, although the examples illustrated in FIG. 11 and FIG. 12 described above are configured to calculate blue time final adjustment value FPA_{L,t} for indication L and blue time final adjustment value FPA_{M,t} for indication M by using ΔIPAₜ at time t, an adjustment value at time t−1 may be determined based on, for example, following Equation (7.1) and Equation (7.2) in consideration of delay in travel time measurement. Time t−1 here is merely an example, and for example, time t−2 can also be used.

$$\begin{matrix}[ Equation 11 ] & \\ {FPA}_{L , t} = Δ {IPA}_{i - 1} & ( 7.1 ) \\ [ Equation 12 ] & \\ {FPA}_{M , t} = - 1 * Δ {IPA}_{t - 1} * \frac{Number of Data of L}{Number of Data of M} & ( 7.2 )\end{matrix}$$

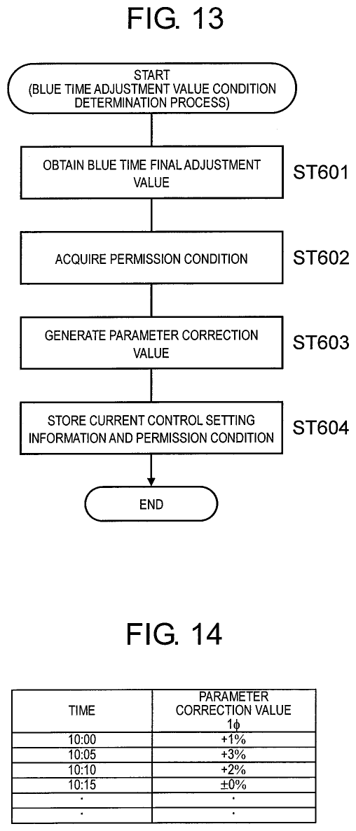

FIG. 13 is a flowchart illustrating an example of the blue time adjustment value condition determination process (ST104) in FIG. 6A, and FIG. 14 is an explanatory diagram illustrating an example of a parameter correction value generated in step ST603 in FIG. 13.

In the blue time adjustment value condition determination process, first, additional device 2B obtains blue time final adjustment value FPA_{k,t} relating to signal indication k calculated by the above-described blue time adjustment value determination process as the blue time adjustment value (ST601), and furthermore, acquires a permission condition for the blue time adjustment value (ST602). The permission condition may be, for example, an upper limit value and a lower limit value of the blue time value (or the blue time adjustment value).

Subsequently, additional device 2B generates a parameter correction value obtained by correcting the blue time adjustment value based on the acquired permission condition, for example, as illustrated in FIG. 14 (ST603). In this case, for example, in a case where the blue time adjustment value based on the permission condition exceeds the upper limit value, the upper limit value of the blue time can be set as the parameter correction value. Further, for example, in a case where the blue time adjustment value based on the permission condition is less than the lower limit value, the lower limit value of the blue time can be set as the parameter correction value. The generated parameter correction value is stored in parameter correction value storage 33.

In this way, by setting the upper limit value and the lower limit value (or at least one) of the blue time of the signal control parameter of the current signal control information as the permission condition, it is possible to avoid that an inappropriate passage permission time is set based on a simple condition for the traffic light of a control target. Further, in a case where the blue time adjustment value does not satisfy the permission condition, the blue time adjustment value is corrected (a parameter correction value is generated) so as to satisfy the permission condition, and thereby, it is possible to set an appropriate blue time adjustment value within a range satisfying the permission conditions.

Thereafter, additional device 2B stores the current control setting information (or a signal control parameter) before applying the parameter correction value as a backup, and further stores the blue time adjustment value relating to the generated parameter correction value and information on the permission condition as well (ST604). Additionally, additional device 2B can also store a history of the parameter correction values, and the like.

In this way, by storing the blue time information of the control setting information before the parameter correction value (blue time adjustment value) is applied, even in a case where the adjustment value of the traffic permission time is not valid (for example, a case where a desirable effect on traffic is not obtained, or a case where a traffic manager determines that a value is inappropriate), the adjusted blue time can be easily changed to the value before the adjustment.

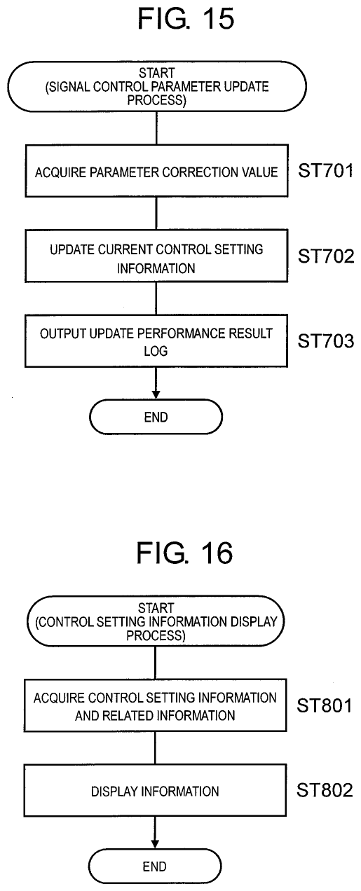

FIG. 15 is a flowchart illustrating an example of the signal control parameter update process (ST105) in FIG. 6B. In the signal control parameter update process, first, additional device 2B acquires the parameter correction value calculated through the above-described blue time adjustment value condition determination process (ST701) and updates (overwrites) the control setting information in control setting information storage 13 by using the parameter correction value (or a signal control parameter including the parameter correction value) (ST702). Thereafter, additional device 2B outputs and stores a result log of the update performance (ST703). A traffic manager can always monitor the control setting information, and in a case where there is a change in information on a signal control (for example, a change in a signal indication), the signal control parameter update process can be stopped.

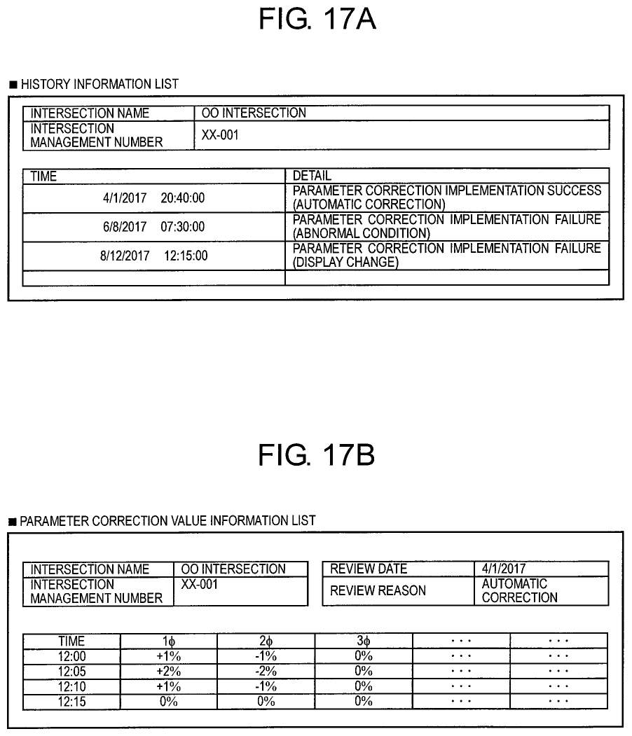

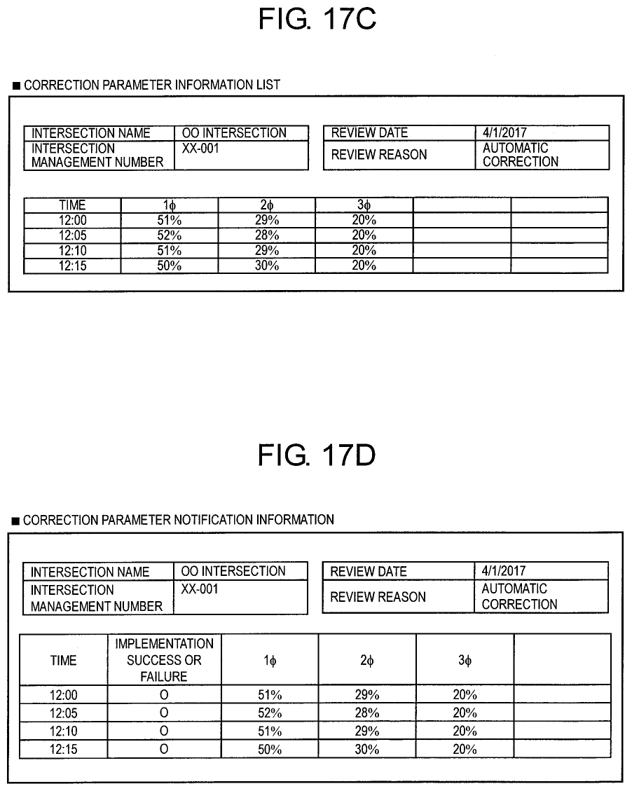

FIG. 16 is a flowchart illustrating an example of the control information display process (ST106) in FIG. 6C, and FIGS. 17A to 17D are explanatory diagrams illustrating examples of a history information list, a parameter correction value information list, a corrected parameter (blue time) information list, and notification information on the corrected parameter, which are displayed in the process of step ST802 in FIG. 16, respectively.

As illustrated in FIG. 16, in the control information display process, first, control setting information and related information (change history, control setting information for backup, and the like) from main body device 2A are acquired (ST801), and the information is displayed on a display device including control information display unit 25 (802).

As information displayed in the control information display process, for example, as illustrated in FIG. 17A, the history information list includes information on success or failure of implementation (generation of parameter correction values) of correction of the blue time adjustment value at a predetermined date and time in relation to a target intersection (name, management number). Further, for example, as illustrated in FIG. 17B, the parameter correction value information list includes a parameter correction value for each signal indication (here, three indications of 1Φ-3Φ) at a predetermined time. Further, for example, as illustrated in FIG. 17C, the corrected parameter (blue time) information list includes a value (here, a ratio to a cycle length) of the parameter (here, the blue time) after the parameter correction value is applied in relation to each signal indication (here, three indications of 1Φ-3Φ) at a predetermined time. Further, for example, as illustrated in FIG. 17D, the notification information on the corrected parameter includes information on success or failure (here, a circle indicates that the implementation was effective) of implementation of parameters illustrated in FIG. 17C. By displaying such information, a traffic manager can easily determine whether or not the determined blue time adjustment value (parameter correction value) is appropriate.

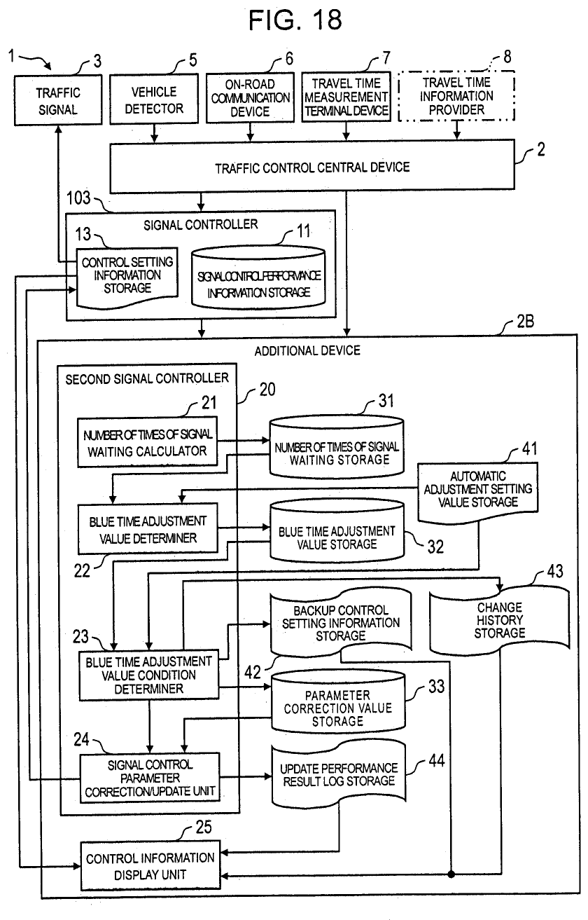

FIG. 18 is an overall configuration diagram illustrating a modification example of signal control system 1 according to the present embodiment. In FIG. 18, the same configuration elements as the configuration elements of signal control system 1 illustrated in FIG. 2 described above are denoted by the same reference numerals, and items not particularly described below are the same as the items described above.

In the example of FIG. 2 described above, additional device 2B is provided as a part of traffic control central device 2, but the present invention is not limited to this, and, for example, additional device 2B configured with a maintenance computer installed on a roadside can also be configured to be attached to signal controller (signal control device) 103 installed together with traffic light 3 (here, mainly configured with a signal lamp) as illustrated in FIG. 18. Thereby, it is possible to perform a process of adjusting blue time in a signal control parameter even for traffic light 3 that is not under a control of traffic control central device 2.

As described above, although the present disclosure was described based on specific embodiments, the embodiments are merely examples, and the present disclosure is not limited by the embodiments. Each configuration elements of the signal control device, the signal control system, the signal control method, and the signal control program according to the present disclosure illustrated in the above-described embodiments are not necessarily essential, and as long as the units do not depart from at least the scope of the present disclosure, an appropriate selection can be made.

### INDUSTRIAL APPLICABILITY

A signal control device, a signal control system, a signal control method, and a signal control program according to the present disclosure enable a control of a traffic light according to a continuous change in a traffic condition, and is useful as a signal control device, a signal control system, a signal control method, a signal control program, and the like that provide signal control information for controlling a traffic light installed at an intersection or the like.

### REFERENCE MARKS IN THE DRAWINGS

1 SIGNAL CONTROL SYSTEM
2 TRAFFIC CONTROL CENTRAL DEVICE (SIGNAL CONTROL DEVICE)
2A MAIN BODY DEVICE
2B ADDITIONAL DEVICE
3 TRAFFIC LIGHT
4 VEHICLE
5 VEHICLE DETECTOR
6 ON-ROAD COMMUNICATION DEVICE
7 TRAVEL TIME MEASUREMENT TERMINAL DEVICE
8 TRAVEL TIME INFORMATION PROVIDER
11 SIGNAL CONTROL PERFORMANCE INFORMATION STORAGE
12 TRAVEL TIME INFORMATION STORAGE
13 CONTROL SETTING INFORMATION STORAGE
14 FIRST SIGNAL CONTROLLER
20 SECOND SIGNAL CONTROLLER
21 NUMBER OF TIMES OF SIGNAL WAITING CALCULATOR
22 BLUE TIME ADJUSTMENT VALUE DETERMINER
23 BLUE TIME ADJUSTMENT VALUE CONDITION DETERMINER
24 SIGNAL CONTROL PARAMETER CORRECTION/UPDATE UNIT
25 CONTROL INFORMATION DISPLAY UNIT
31 NUMBER OF TIMES OF SIGNAL WAITING STORAGE
32 BLUE TIME ADJUSTMENT VALUE STORAGE
33 PARAMETER CORRECTION VALUE STORAGE
41 AUTOMATIC ADJUSTMENT SETTING VALUE STORAGE
42 BACKUP CONTROL SETTING INFORMATION STORAGE (BACKUP INFORMATION STORAGE)
43 CHANGE HISTORY STORAGE
44 UPDATE PERFORMANCE RESULT LOG STORAGE
103 SIGNAL CONTROLLER (SIGNAL CONTROLLER)

1. A signal control device including a processor that provides signal control information for controlling a traffic light installed at an intersection,
wherein the processor
calculates number of times of signal waiting of a vehicle in a plurality of vehicle outflow directions at the intersection, and
determines an adjustment value of a passage permission time for the signal control information of the traffic light relating to the vehicle outflow direction, based on the number of times of signal waiting.

2. The signal control device of claim 1, wherein the determination of the adjustment value of the passage permission time is performed at a predetermined cycle.

3. The signal control device of claim 1, wherein the number of times of signal waiting is calculated based on a travel time of a target vehicle passing through the intersection.

4. The signal control device of claim 3, wherein the number of times of signal waiting is calculated based on a difference between the calculated travel time and a reference time set for a travel path of a vehicle relating to the travel time.

5. The signal control device of claim 1, wherein the number of times of signal waiting is calculated based on a passage prohibition time of a target vehicle in the vehicle outflow direction.

6. The signal control device of claim 1, wherein the processor determines whether or not the adjustment value of the passage permission time satisfies a preset permission condition.

7. The signal control device of claim 6, wherein the permission condition includes at least one of an upper limit value and a lower limit value of the passage permission time in the signal control information.

8. The signal control device of claim 6, wherein the processor corrects the adjustment value of the passage permission time such that the permission condition is satisfied in a case where the adjustment value of the passage permission time does not satisfy the permission condition.

9. The signal control device of claim 1, further comprising:
a backup information storage that stores information of the passage permission time before the adjustment value of the passage permission time is applied.

10. The signal control device of claim 1, wherein the processor calculates number of times of signal waiting of a vehicle for each of the plurality of vehicle outflow directions to which different indications are applied in the traffic light, and determines the adjustment value of the passage permission time for each of the vehicle outflow directions, based on a plurality of the number of times of signal waiting.

11. The signal control device of claim 10, wherein the plurality of vehicle outflow directions include a plurality of outflow directions relating to vehicles whose inflow directions to the intersection are the same as each other.

12. The signal control device of claim 1, further comprising:
a display unit that displays the determined adjustment value of the passage permission time.

13. A signal control system comprising:
the signal control device according to claim 1; and
an on-road communication device that acquires information on a travel time of a vehicle passing through the intersection.

14. A signal control method of providing signal control information for controlling a traffic light installed at an intersection comprising:
calculating number of times of signal waiting of a vehicle in a plurality of vehicle outflow directions at the intersection, and
determining an adjustment value of a passage permission time for the signal control information of the traffic light relating to the vehicle outflow direction, based on the number of times of signal waiting.
